(19) United States
(12) Patent Application Publication
(10) Pub. No.: US 2015/0334009 A1
(43) Pub. Date: Nov. 19, 2015

(54) System for monitoring the performance of flows carried over networks with dynamic topology

(71) Applicants: Alan Douglas Clark, Duluth, GA (US); Shane Holthaus, Duluth, GA (US)

(72) Inventors: Alan Douglas Clark, Duluth, GA (US); Shane Holthaus, Duluth, GA (US)

(73) Assignee: Telchemy, Incorporated, Duluth, GA (US)

(21) Appl. No.: 14/120,405

(22) Filed: May 19, 2014

(51) Int. Cl. H04L 12/721; H04L 12/751; H04L 12/46; H04L 12/741; H04L 12/723; H04L 12/801; H04L 12/26

(52) U.S. Cl. CPC H04L 45/38; H04L 47/18; H04L 45/02; H04L 43/12; H04L 45/74; H04L 45/50; H04L 12/4641

(57) ABSTRACT

A method and system for monitoring the performance of end to end flows traversing a network with rapidly changing topology and with address translation and encapsulation. Multiple probes are deployed within the network and a dynamic mapping method used to enable probes to associate local address information with end to end flow identifiers.

### BACKGROUND OF THE INVENTION

Emerging networks have topologies that rapidly evolve, the paths established through such networks are transient in nature and flow identifying information such as IP addresses may be overlapping or translated within the network. This means that conventional approaches to monitoring packet stream performance within the network will not be able to relate measurement data from a stream at different points within the network. The present invention allows the performance of flows carried over networks with dynamically changing topology and translated or encapsulated packet identifiers to be measured and correlated.

Emerging networks, including Mobile Ad Hoc Networks (MANETs) and software defined networks (SDNs) have topologies that change dynamically. In such networks, the establishment of routes may be determined by a centralized control function, in contrast to the distributing routing control that has been widely used in networks. This centralized control function may itself be a distributed function, to provide resilience and support variable loading, however acts as a centralized function. The use of a centralized control function allows routes to be established very quickly and easily modified to improve traffic loading throughout the network. Routes may be established in fractions of a second and may persist for short time periods.

IP (Internet Protocol) networks route packets based on a destination IP address and in some cases the combination of an IP address and a Virtual LAN (VLAN) identifier or tag or an MPLS label is used. The use of VLAN tags or MPLS labels allows networks to carry traffic from different networks with overlapping IP address spaces. For example, a service provider may carry traffic from two business customers, A and B, and each business customer may internally use the same range of IP addresses; the service provider can assign each customer to a different VLAN and then route packets based on the combination of VLAN tag and IP address.

A VLAN identifier is typically local in scope, for example may only be assigned to the packets carried between one switch and another. VLAN identifiers may be added onto existing packets and a packet may have between zero and three VLAN tags. The VLAN identifier used to separate one set of IP packets from another may thus change as the set of IP packets traverse the network. This means that a packet carried across a network using VLANs may be uniquely identified at different points only if the specific VLAN and the IP address are known for each of said point.

For example:
(i) A packet with source IP address 192.168.1.1 and destination IP address 192.168.10.1 is carried through a first link from origin “X” with VLAN tag 1234 prepended, and a second link with VLAN tag 2345 and a third link with VLAN tag 3456 to destination “Y”.
(ii) The network carries other IP packets with IP address ranges 192.168.1.N and 192.168.10.N from other networks and uses other VLAN tags to separate these packets from the packet described in (i).
(iii) An observer at the second link sees the packet with source address 192.168.1.1 and destination address 192.168.10.1, and wishes to associate this packet with its origin and destination. If the observer knows that VLAN tag 2345 combined with the IP address 192.168.1.N and 192.168.10.N belongs to the flow X-Y then they can associate the packet with this flow. If the observer does not know which VLAN tag and IP address range on this second link relates to which flow then they cannot associate the packet with a flow.

In networks with stable topology (static or slow changing), the association of local VLAN tags on links within the network to flows may be known. In this case the probe reports the combination of IP address and VLAN tag to the network management system responsible for data and the network management system is able to associate the measurements on the path of a flow.

For networks with dynamically changing topology, the association of flows with VLAN tags and IP address ranges is transient and can change quickly. This type of network typically uses a centralized routing control function that can rapidly establish a path through a network by making a series of explicit configuration changes to each switch or router along the desired path. These configuration changes may for example comprise a mapping of an input IP address range—VLAN tag pair to an output interface—VLAN tag pair, or to an output interface—IP address—VLAN tag triple.

Another complication is that IP addresses may be changed within the network in order to allow IP address re-use or for security. Such IP address modification is performed using Network Address Translation or NAT or in some cases by a gateway or proxy function such as a back-to-back user agent. This means that the IP address associated with a packet may change as it traverses the network.

The monitoring of flows through such dynamically changing networks, potentially with IP address translation, is rendered impractical as a conventional probe (observer) sees packets with IP addresses and VLAN tags that change on the path through the network and which may exist only for short periods of time, which makes the mapping of packet identification data to end-to-end flows infeasible due to the frequency and speed of changes to the configuration of the switches within the network.

### BRIEF SUMMARY OF THE INVENTION

The present invention provides a method for monitoring packets within a network with dynamically changing topology that allows the association of packets with end-to-end flows to be performed. This allows the performance of services and packet flows through such networks to be monitored whereas with prior art approaches it would be impossible to perform such monitoring.

### DISCUSSION OF THE PRIOR ART

A number of approaches have been explored within the prior art to the identification of paths within a network however these differ significantly from the present invention.

U.S. Pat. No. 6,651,099 [Dietz] defines a method by which packets passing through a connection point are examined and associated with a flow-entry database or table, allowing data to be gathered about the flow. This differs from the present invention in that the flow table described by Dietz is related only the locally defined flow (p-Flow) whereas the present invention is specifically related to the independent problem of correlating the individual local flows with an end to end flow. Dietz method would have the problem described in paragraphs 7-9 above in that it could not be employed in a network with rapidly changing topology.

Fayazbakhsh, Sekar, Yu and Mogul [ HotSDN, August 13, 2013] describe “FlowTags” as a method for enabling flow tracking. This method requires the addition of a Tag to each packet that traverses an SDN, thereby allowing the flow to be identified end to end. This does however require modifications to switches and routers in order that such Tags can be added and remove, and also makes each packet larger. In a high capacity network with large numbers of flows the Tag may have to be quite long in order to guarantee global uniqueness and may substantially increase packet size. The present invention is able to solve the problem of end to end flow identification without any modification to the packets traversing the network and without making packets larger.

IETF RFC 6016 describes a method for reservation of resources in which a Path message is transmitted from a source to a destination, and this message makes resource reservations along the path traversed. The Path message contains a definition of the resources required for the connection in order that routers can reserve these. This type of message could not be used to achieve the goals of the present invention as it does not define an end to end flow identifier that could be uniquely used to correlate monitored parts of the flow and further, its use would cause inadvertent reservation of resources.

### BRIEF DESCRIPTION OF THE INVENTION

The preferred embodiment of the present invention is described below however the scope of the present invention contemplates other embodiments that perform the equivalent function.

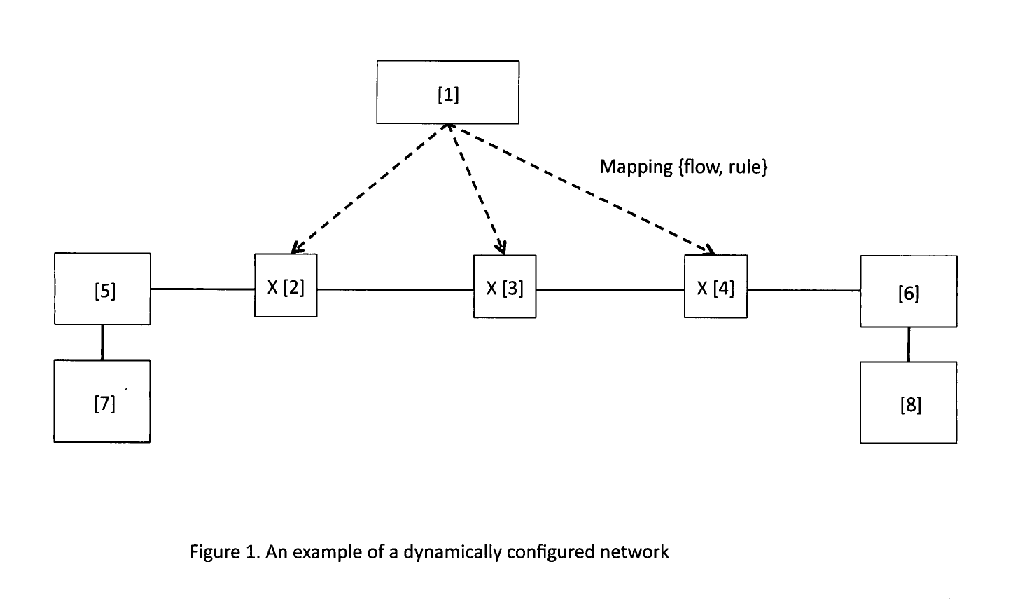

FIG. 1 shows the key components of a network with dynamic topology. The network comprises a control function [1], a series of switches [2-4], and a pair of terminating networks [5, 6].

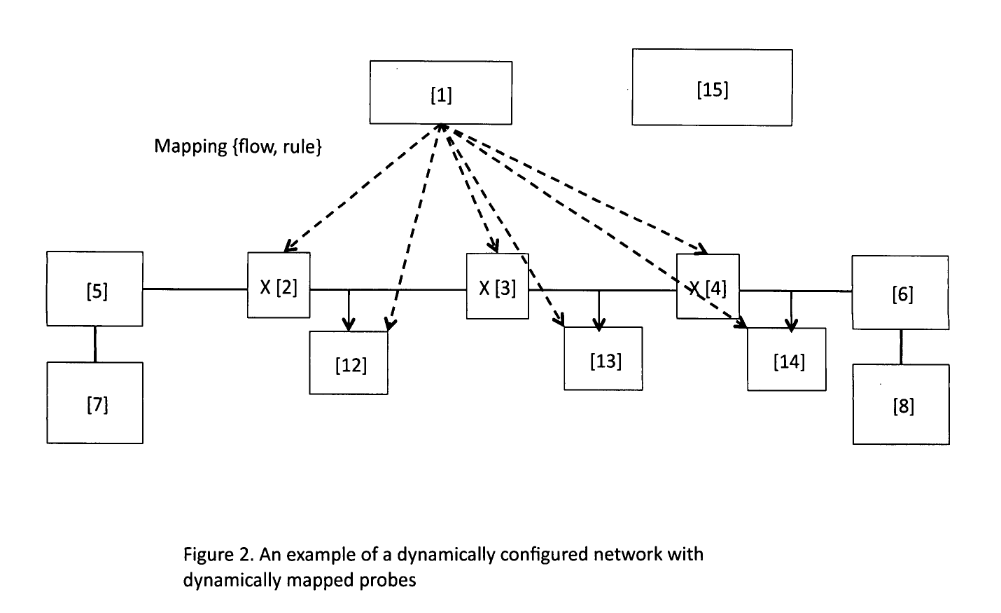

FIG. 2 shows the network of FIG. 1 augmented to show a series of Probe functions [12-14] and a Reporting Application [15].

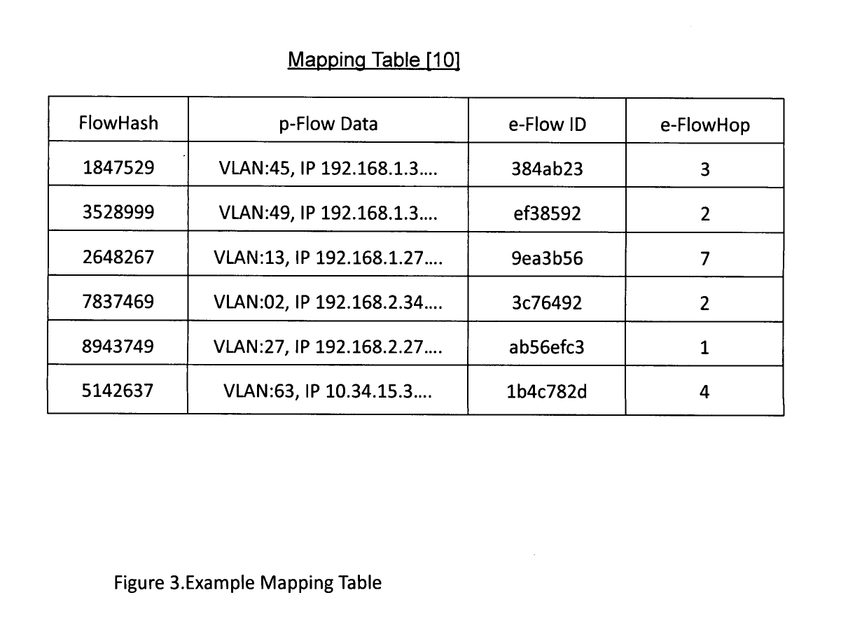

FIG. 3 shows a Mapping Table [10], which is used to relate end-to-end flows to local packet identification information within a Probe [12-14].

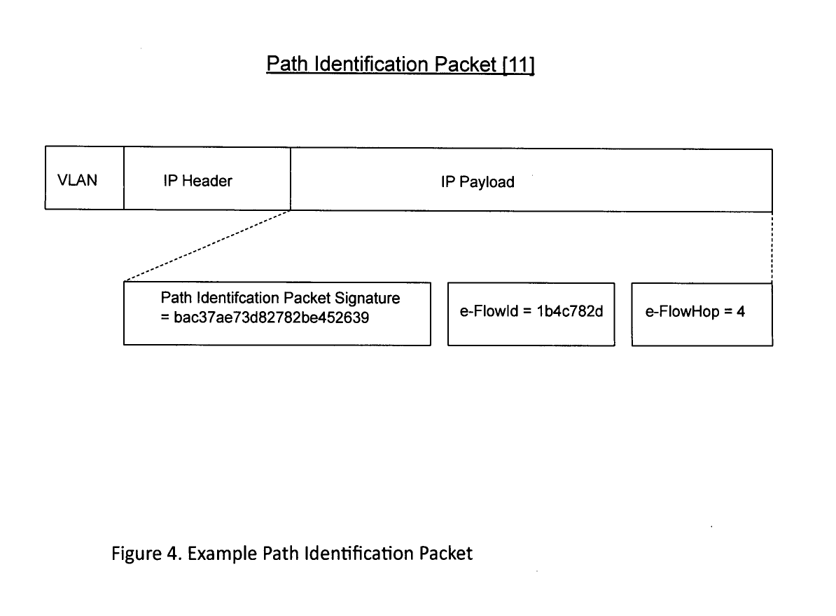

FIG. 4 shows a Path Identification Packet [11], which enables a Probe [12-14] to discover the end-to-end flow to local path identification relationship

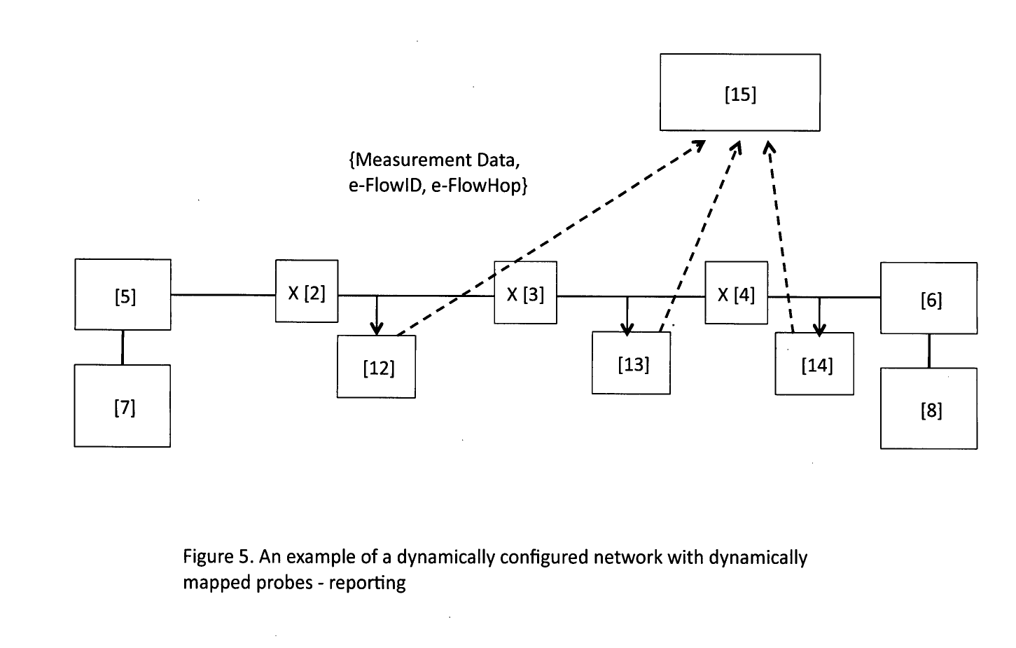

FIG. 5 shows the network of FIG. 2 and illustrates the reporting of data from Probes [12-14] to the Reporting Application [15]

### DETAILED DESCRIPTION OF THE INVENTION

The flow from one endpoint 7 to the other endpoint 8 is defined herein as an e-Flow (for end-to-end flow), and the individual segment of the flow that occur between two switches is defined herein as a p-Flow. An e-Flow consists of a number of sequential p-Flows. A p-Flow is identified as the combination of a source and/or destination IP address range and a VLAN tag or equivalent such as an MPLS label.

An application 7 in terminating network 5 wishes to establish a transient connection with an application 8 in terminating network 6. Network 5 has IP address range 192.168.1.1-100 A connection request is made by application 7 to control function 1. Control function 1 determines that an optimum route exists from network 5 to network 6 through switches 2, 3 and 4. Control function 1 sends a sequence of commands to switches 2, 3 and 4 to establish a mapping from input p-Flow to output p-Flow through each switch with a corresponding VLAN tag.
(a) Control Function 1 creates an e-Flow identifier e-FlowID for the new end to end flow. This comprises a random identifier that is unique within this network.
(b) Control Function 1 sends mapping {p-Flow 2^{IN}, p-Flow 2^{OUT}} to switch 2
(c) Control Function 1 sends mapping {p-Flow 3^{IN}, p-Flow 3^{OUT}} to switch 3
(d) Control Function 1 sends mapping {p-Flow 4^{IN}, p-Flow 4^{OUT}} to switch 4

Each switch would typically be configured with many such mappings and would be concurrently routing large numbers of packets between multiple sources and multiple destinations. As soon as the connection is no longer needed, Control function 1 sends a sequence of commands to switches 2, 3 and 4 to remove the mappings within each switch, thereby freeing switch resources for other such paths.

The operation of the network described above and illustrated in FIG. 1 is characteristic of a software defined network such as OpenFlow.

FIG. 2 shows the network of FIG. 1 with the addition of a number of Probes [12-14] located adjacent to each switch [2-4].

Within the present invention, Control function 1 dynamically configures a Probe at approximately the same time as it configures the switch preceding the Probe.

Extending the description above to include dynamic configuration of the Probes, when the Control Function creates the path through the network:
(a) Control Function 1 creates an e-Flow identifier e-FlowID for the new end to end flow. This comprises a random identifier that is unique within this network.
(b) Control Function 1 sends mapping {p-Flow 2^{IN}, p-Flow 2^{OUT}} to switch 2
(c) Control Function 1 sends mapping {p-Flow 2^{IN}, e-FlowID, e-FlowHop} to Probe 12, where e-FlowHop is set to 1.
(d) Control Function 1 sends mapping {p-Flow 3^{IN}, p-Flow 3^{OUT}} to switch 3
(e) Control Function 1 sends mapping {p-Flow 3^{OUT}, e-FlowID, e-FlowHop} to Probe 13, where e-FlowHop is set to 2.
(f) Control Function 1 sends mapping {p-Flow 4^{IN}, p-Flow 4^{OUT}} to switch 4
(g) Control Function 1 sends mapping {p-Flow 4^{OUT}, e-FlowID, e-FlowHop} to Probe 14, where e-FlowHop is set to 3.

Each Probe [12-14] maintains a table [10] of p-Flow to e-FlowID and e-FlowHop mappings that have been provided by Control Function 1, and adds a new mapping to this table when it is received from Control Function 1 and removes a mapping when Control Function 1 sends a mapping deletion instruction.

The Mapping Table [10] comprises an array of rows held in the memory of the Probe, where each row contains (i) a set of p-Flow data such as source IP address, destination IP address and VLAN tag, (ii) an e-FlowID identifier which is a numeric or alphanumeric string, (iii) e-FlowHop which is a numeric value and optionally (iv) a FlowHash value used for rapid comparison of the observed p-Flow data from a received packet with the p-Flow data stored in said row of said Mapping Table. Said Mapping Table will be organized as a linear array or hash table or linked list, which methods are well known to those skilled in the art.

If the Control Function 1 needs to change the route through the network in order to allow for changes in traffic patterns then it will send similar commands to each switch and Probe in order to modify these mappings.

Each Probe [12-14] sees packets traversing the link to which the Probe is attached. Each such packet will be identified by an IP address and a VLAN tag or MPLS LSP or some equivalent encapsulation and the set of packets sharing a common IP address and VLAN tag, or more generally matching a p-Flow definition, are grouped into a flow (which is defined herein as a p-Flow) and measured. The Probe performs measurements on each packet or on a sequence of packets within a p-Flow and collects said measurement data for each observed p-Flow. Prior to generating a report, the Probe selects the IP address, VLAN tag and other p-Flow identification data and performs a lookup in the Mapping Table [10]. The e-FlowID and e-FlowHop obtained from said lookup are combined with the set of data associated with said measurement on said p-Flow and sent to Reporting Application 15.

Reporting Application 15 receives a series of sets of data from each Probe, where each data set comprises an e-FlowID, an e-FlowHop and a set of measurement data. Reporting Application 15 combines the sets of data corresponding to a single e-FlowID into a single connected set of database records.

Reporting Application 15 allows a user, through a user interface, to request measurement data associated with an e-Flow. Reporting Application 15 accepts an e-FlowID from a user, or performs a translation of data provided by the user to an e-FlowID, and performs a database query to retrieve the set of connected database records corresponding to said e-FlowID.

Reporting Application 15 may also order each such database record by e-FlowHop and compare the metrics from each record, indicating to the user the point in the network at which metrics differ from the previous point.

The metrics reported by Probes [12-14] for each flow may comprise counts of observed packets, counts of lost packets, a measurement of the peak or average bandwidth of the packet stream, an average packet arrival time or inter-arrival time delay variation value, a service health metric for the application that is generating or receiving the stream such as a speech, audio or video MOS score, a usage metric such as a measurement of the number or proportion of time intervals during which bandwidth exceeded defined thresholds, and a metric that counts the number of times that the pattern of values within a packet matches the signature of a known virus or attack vector.

The above description of the preferred embodiment represents an example of the present invention however there are other possible embodiments that would fall within the scope of this invention.

The network may be a software defined network, or a mobile ad hoc network, or a mobile network or a virtual private network or a multi-protocol label switched network or a satellite network or a voice over IP service.

A p-Flow may be identified by a source IP address, a source IP address range, a destination IP address, a destination IP address range, a VLAN identifier, an MPLS LSP, a GRE identifier, a VPN tunnel, or a combination of these.

It is preferred that the Control Function 1 sends p-Flow to e-Flow mappings directly to the Probe functions however the Control Function may forward such mappings indirectly through a proxy server or the Probe may request a mapping for a p-Flow for which it has not received a p-Flow to e-Flow mapping. A proxy server could be an independent server or could be a proxy function embedded into the switch to which the Probe is attached.

A further function of a Probe [12-14] may be to monitor the configuration messages sent from the Control Function [1] to the switch local to the Probe. The Probe may then capture and record such messages in order to automatically detect if configuration messages are being rejected by the switch or to allow later analysis of the messages for troubleshooting or network optimization.

A further improvement would be for the Probe [12-14] to detect configuration messages sent from the Control Function [1] to the Switch local to the Probe, and to use the configuration data from said messages to generate the e-Flow to p-Flow mapping within the Probe. This would make it unnecessary for the Control Function to send configuration messages to each Probe in addition to each switch or router.

An alternative embodiment would be to integrate the Probe [12-14] function into the switch, and combine the configuration of the switch and the configuration of the Probe. This would require that the configuration data sent to the switch included an e-FlowID in addition to the input-output mapping that Would typically be sent.

A further improvement would be to define a data format that contains a unique signature that identifies the packet as a Path Identification Packet [11] and incorporates an e-FlowID and an optional timestamp. The unique signature is a long sequence of byte values that is statistically unlikely to occur within other packets, for example a 128 byte sequence of pseudo-random values; the sequence may consist of a short pre-amble that has constant values followed by a longer algorithmically generated pseudo-random sequence. The Path Identification Packet [11] is sent between the source and the destination when a path is established through a dynamically configured network and periodically thereafter. Each Probe monitors each arriving packet to detect Path Identification Packets; when one of said Path Identification Packets is detected the Probe extracts the e-FlowID and e-FlowHop from within the Path Identification Packet and the VLAN tags, IP addresses and other flow identification data from the headers of the Path Identification Packet and builds the entry in its Mapping Table [10]. This has the advantage that the Control Function does not need to configure the Probes however does require the applications or the host computers on which they run or the local area networks in which they are connected to generate said Path Identification Packets. Said Path Identification Packet may be used for other functions within the network such as authentication that the end systems are permitted to use the path, gathering data on the usage of network resources by end systems for billing purposes, verification that a path has been established through the network and measurement of end-to-end delay.

1. A system for monitoring an end to end network connection within a network with dynamic topology in which said monitoring is performed by a probe function, wherein said probe function has an interface through which mappings between a locally identified packet flow and an end to end flow are dynamically configured and electronic memory in which at least two of said mappings are stored. Said probe function performs the steps of
(i) receiving and storing a configuration instruction that contains at least a mapping between a local packet flow identifier and an end to end flow identifier
(ii) obtaining measurements of the packet streams observed at the input to the probe
(iii) determining a local packet flow identifier for each of said packet streams and searching within said electronic memory to find said local packet flow identifier and the associated end to end flow identifier
(iv) combining said measurement of said packet stream with said end to end flow identifier and sending said combined measurement and end to end flow identifier to a reporting application

2. A system as defined in claim 1 where said local packet flow identifier is selected from the set:
(i) a source IP address
(ii) a source IP address range
(iii) a destination IP address
(iv) a destination IP address range
(v) a source and a destination IP address
(vi) a source and a destination IP address range
(vii) a Virtual LAN identifier
(viii) a Virtual LAN identifier and a source IP address range
(ix) a Virtual LAN identifier and a destination IP address range
(x) a Virtual LAN identifier and a source and destination IP address range
(xi) an MPLS Label Switched Path (LSP) identifier
(xii) an MPLS Label Switched Path (LSP) and a source IP address range
(xiii) an MPLS Label Switched Path (LSP) and a destination IP address range
(xiv) an MPLS Label Switched Path (LSP) and a source and destination IP address range

3. A system as defined in claim 1 where the end-to end flow identifier is selected from the set:
(i) an alphanumeric flow identifier string
(ii) an alphanumeric flow identifier string and an numeric hop identifier
(iii) an alphanumeric flow identifier string and an numeric hop identifier and an alphanumeric identifier

4. A system as defined in claim 1 where the measurement data is selected from the set:
(i) A count of packets observed
(ii) A count of packets lost
(iii) The average variation in the arrival time of packets
(iv) The average variation in the inter-arrival time of packets
(v) A service health index that estimates the performance of the application that is generating the packet stream
(vi) A service health index that estimates the performance of the application that is receiving the packet stream
(vii) A resource usage metric that estimates the peak and average bandwidth usage of the application that is generating the packet stream
(viii) A threat index metric that is responsive to the presence of security threats within the packet stream

5. A system for monitoring an end to end network connection within a network with dynamic topology in which said monitoring is performed by a probe function containing electronic memory in which mappings between a locally identified packet flow and an end to end flow identifier are stored, where said probe function performs the steps of:
(i) monitoring the packet stream at an interface to detect Path Identification Packets,
(ii) if a Path Identification Packet is detected, then creating a packet flow identifier from the address data of said Path Identification Packet and storing a mapping between said packet flow identifier and an end to end flow identifier extracted from within said Path Identification Packet
(iii) obtaining measurements of the packet streams observed at the input to the probe
(iv) determining a local packet flow identifier for each of said packet streams and searching within said electronic memory to find said local packet flow identifier and the associated end to end flow identifier
(v) combining said measurement of said packet stream with said end to end flow identifier and sending said combined measurement and end to end flow identifier to a reporting application

6. A system as defined in claim 5 where said local packet flow identifier is selected from the set:
(i) a source IP address
(ii) a source IP address range
(iii) a destination IP address
(iv) a destination IP address range
(v) a source and a destination IP address
(vi) a source and a destination IP address range
(vii) a Virtual LAN identifier
(viii) a Virtual LAN identifier and a source IP address range
(ix) a Virtual LAN identifier and a destination IP address range
(x) a Virtual LAN identifier and a source and destination IP address range
(xi) an MPLS Label Switched Path (LSP) identifier
(xii) an MPLS Label Switched Path (LSP) and a source IP address range
(xiii) an MPLS Label Switched Path (LSP) and a destination IP address range
(xiv) an MPLS Label Switched Path (LSP) and a source and destination IP address range

7. A system as defined in claim 5 where the end-to end flow identifier is selected from the set:
(i) at least one alphanumeric flow identifier string
(ii) an alphanumeric flow identifier string and an alphanumeric hop identifier
(iii) an alphanumeric flow identifier string and an alphanumeric hop identifier and an alphanumeric identifier

8. A system as defined in claim 5 where the measurement data is selected from the set:
(i) A count of packets observed
(ii) A count of packets lost
(iii) The average variation in the arrival time of packets
(iv) The average variation in the inter-arrival time of packets
(v) A service health index that estimates the performance of the application that is generating the packet stream
(vi) A service health index that estimates the performance of the application that is receiving the packet stream
(vii) A resource usage metric that estimates the peak and average bandwidth usage of the application that is generating the packet stream
(viii) A threat index metric that is responsive to the presence of security threats within the packet stream

9. A system for monitoring an end to end network connection within a network with dynamic topology in which said monitoring is performed by a probe function containing electronic memory in which mappings between a locally identified packet flow and an end to end flow identifier are stored, where said probe function performs the steps of:
(i) monitoring the packet stream at an interface to detect configuration packets sent from a Control Function to a Switch,
(ii) if a configuration packet is detected, then creating a packet flow identifier and an end to end flow identifier from the data within said configuration packet and storing the mapping between said packet flow identifier and said end to end flow identifier
(iii) obtaining measurements of the packet streams observed at the input to the probe
(iv) determining a local packet flow identifier for each of said packet streams and searching within said electronic memory to find said local packet flow identifier and the associated end to end flow identifier
(v) combining said measurement of said packet stream with said end to end flow identifier and sending said combined measurement and end to end flow identifier to a reporting application

10. A system as defined in claim 9 where said local packet flow identifier is selected from the set:
(i) a source IP address
(ii) a source IP address range
(iii) a destination IP address
(iv) a destination IP address range
(v) a source and a destination IP address
(vi) a source and a destination IP address range
(vii) a Virtual LAN identifier
(viii) a Virtual LAN identifier and a source IP address range
(ix) a Virtual LAN identifier and a destination IP address range
(x) a Virtual LAN identifier and a source and destination IP address range
(xi) an MPLS Label Switched Path (LSP) identifier
(xii) an MPLS Label Switched Path (LSP) and a source IP address range
(xiii) an MPLS Label Switched Path (LSP) and a destination IP address range
(xiv) an MPLS Label Switched Path (LSP) and a source and destination IP address range

12. A system as defined in claim 9 where the end-to end flow identifier is selected from the set:
(i) at least one alphanumeric flow identifier string
(ii) an alphanumeric flow identifier string and an alphanumeric hop identifier
(iii) an alphanumeric flow identifier string and an alphanumeric hop identifier and an alphanumeric identifier

13. A system as defined in claim 9 where the measurement data is selected from the set:
(i) A count of packets observed
(ii) A count of packets lost
(iii) The average variation in the arrival time of packets
(iv) The average variation in the inter-arrival time of packets
(v) A service health index that estimates the performance of the application that is generating the packet stream
(vi) A service health index that estimates the performance of the application that is receiving the packet stream
(vii) A resource usage metric that estimates the peak and average bandwidth usage of the application that is generating the packet stream
(viii) A threat index metric that is responsive to the presence of security threats within the packet stream

14. A system as defined in claim 1 wherein said probe is integrated into a router or switch.

15. A system as defined in claim 5 wherein said probe is integrated into a router or switch.

16. A system as defined in claim 9 wherein said probe is integrated into a router or switch.
